(19) United States
(12) Patent Application Publication
(10) Pub. No.: US 2012/0327202 A1
(43) Pub. Date: Dec. 27, 2012

(54) COMMODTIY LIST ISSUING APPARATUS AND METHOD

(75) Inventor: Takeshi NAGAMACHI, Shizuoka-ken (JP)

(73) Assignee: TOSHIBA TEC KABUSHIKI KAISHA, Tokyo (JP)

(21) Appl. No.: 13/488,836

(22) Filed: Jun. 5, 2012

(30) Foreign Application Priority Data
Jun. 22, 2011 (JP) 2011-138855

(51) Int. Cl. H04N 7/18

(52) U.S. Cl. 348/61; 348/E07.085

(57) ABSTRACT

According to one embodiment, a commodity list issuing apparatus comprises an acquisition section, a commodity recognition section, a generation section and an issuing section. The acquisition section configured to acquire an image. The commodity recognition section configured to recognize a commodity according to the acquired image in which the commodity is contained. The generation section configured to generate the commodity information specifying the recognized commodity and a commodity list contains a code symbol generated by coding the commodity information. The issuing section configured to issue the generated commodity list.

### CROSS-REFERENCE TO RELATED APPLICATION

This application is based upon and claims the benefit of priority from Japanese Patent Application No. 2011-138855, filed Jun. 22, 2011, the entire contents of which are incorporated herein by reference.

### FIELD

Embodiments described herein relate to a commodity list issuing apparatus and method.

### BACKGROUND

In an existing eating/drinking establishment where a self service is provided for a customer to select commodities, after distinguishing the commodities selected by a customer, a cashier inputs, one by one, the prices and other information of the commodities.

### BRIEF DESCRIPTION OF THE DRAWINGS

FIG. 1 is a perspective view of a settlement system;

FIG. 2 is a perspective view of a commodity list issuing apparatus;

FIG. 3 is a block diagram illustrating the hardware components of a POS terminal and a commodity list issuing apparatus;

FIG. 4 is a conceptual diagram exemplarily showing the data structure of a FLU file;

FIG. 5 is a block diagram illustrating the functional components of a POS terminal and a commodity list issuing apparatus;

FIG. 6 is a flow chart showing an example of the commodity list issuing actions implemented by a settlement system according to an embodiment;

FIG. 7 is a diagram showing an example of an acquired frame image;

FIG. 8 is a diagram showing an example of a commodity list generated by a commodity list generation section;

FIG. 9 is a diagram showing an example of a commodity list generated by a commodity list generation section;

FIG. 10 is a diagram showing an example of a commodity list generated by a commodity list generation section;

FIG. 11 is a diagram showing an example of a commodity list generated by a commodity list generation section.

### DETAILED DESCRIPTION

According to one embodiment, a commodity list issuing apparatus comprises an acquisition section, a commodity recognition section, a generation section and an issuing section. The acquisition section configured to acquire an image. The commodity recognition section configured to recognize a commodity according to the acquired image in which the commodity is contained. The generation, section configured to generate the commodity information specifying the recognized commodity and a commodity list contains a code symbol generated by coding the commodity information. The issuing section configured to issue the generated commodity list.

Based on an example of a settlement system, the commodity list issuing apparatus, program and method provided in this embodiment are described below with reference to accompanying drawings. The settlement system comprises: a commodity list issuing apparatus configured to issue a commodity list in which the commodities selected by a customer using a self service are contained; and a POS terminal configured as a sales registration apparatus for registering and checking the sales of the commodities settled in one transaction. This embodiment is an application example of a settlement system installed in an eating/drinking establishment where a customer selects a commodity using a self service.

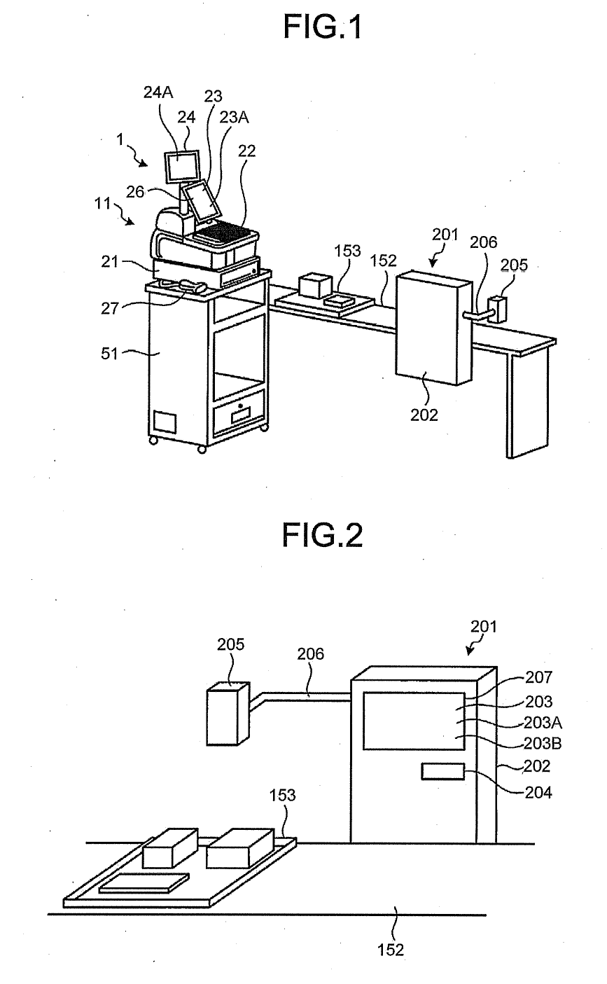

FIG. 1 is a perspective view of the settlement system. FIG. 2 is a perspective view of a commodity list issuing apparatus. As shown in FIG. 1, the settlement system 1 is provided with a POS terminal 11 for registering and checking the sales of the commodities settled in one transaction. The POS terminal 11 is held on the upper surface of a drawer 21 configured on a checkout counter 51. The drawer 21 is opened under the control of the POS terminal 11. A keyboard 22 is configured on the upper surface of the POS terminal 11 for an operator (shop assistant) to operate. Seen from the operator of the keyboard 22, a display 23 for displaying information for the operator is configured more inward than the keyboard 22. The display 23 displays information on the display panel 23A thereof. A touch panel 26 is laminated on the display panel 23A. A vertical customer-oriented display 24 that can be freely rotated is configured at a position more inward than the display 23. The costumer-oriented display 24 displays information on the display panel 24A thereof. Moreover, the customer-oriented display 24 shown in FIG. 1 is rotated in such as manner that the display panel 24A faces the nearer side shown in FIG. 1 and the display panel 23A faces the far side shown in FIG. 1 so as to show information for the customer. Moreover, the POS terminal 11 comprises a scanner 27, which is configured to read the barcode or two-dimensional code and the other code symbols contained in the commodity list issued by the commodity list issuing apparatus 201.

A long desk-shaped counter 151 is configured which forms an L shape with the settlement counter 51 provided with the POS terminal 11. A commodity receiving surface 152 is formed on the upper surface of the counter 151. A commodity tray 153 for holding the commodities selected by the customer using a self service is configured on the commodity receiving surface 152.

The commodity list issuing apparatus 201, which is connected with the POS terminal 11 to transmit data with the POS terminal 11 freely; is configured on the commodity receiving surface 152 of the counter 151. The commodity list issuing apparatus 201 has a thin rectangular housing 202. A display 203, which displays information on the display panel 203A thereof, is configured on the front side of the housing 202 to display information for the customer. A touch panel 203B is laminated on the display panel 203A. Moreover, a printer 204 for printing and outputting various kinds of information is configured below the display 203. Further, a support arm 206 is configured on one lateral side of the housing 20 to support an imaging unit 205 which takes an image in which the commodity images of the commodities held on the commodity tray 153 are contained. The customer places the commodities selected using a self service on the commodity tray 153 held on the commodity receiving surface 152. The commodity tray 153 is manually moved by the customer on the commodity receiving surface 152 towards the POS terminal 11. While being moved, the commodities on the commodity tray 153 come into the imaging range of the imaging unit 205. Then, the imaging unit 205 held on the commodity receiving surface 152 images an image in which the commodity images of the commodities held on the commodity tray 153 are contained. Moreover, the imaging unit 205 is described in detail below.

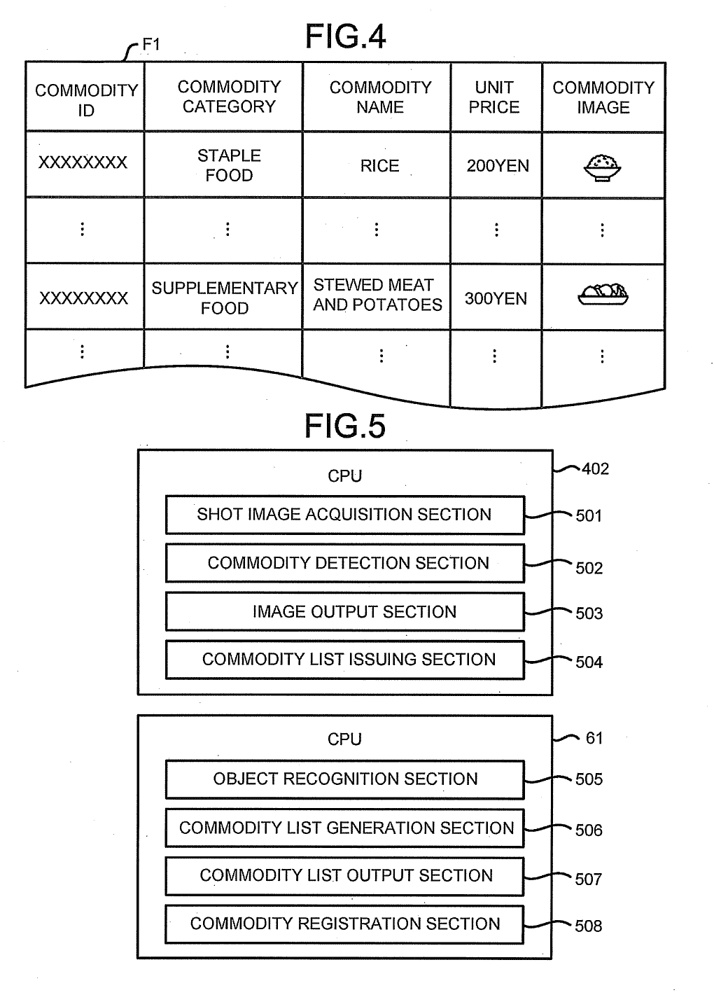

The commodity sales registration flow carried out by the settlement system 1 is briefly explained here. The image imaged by the imaging unit 205 is acquired in the commodity list issuing apparatus 201. Then, the commodity list issuing apparatus 201 outputs the acquired image to the POS terminal 11. In the POS terminal 11, a commodity is recognized from a commodity image contained in the acquired image with reference to a PLU file F1 (refer to FIG. 4) generated by associating the commodity information specifying the commodity with the commodity image. Then, the POS terminal 11 generates a commodity list in which the commodity information of the recognized commodity and a code symbol generated by coding the commodity information are contained. Here, the commodity information refers, for example, to specific commodity information such as commodity ID, commodity category, commodity name and unit price. Moreover, the code symbol refers to a barcode or two-dimensional code that is generated by coding the commodity information. Furthermore, the POS terminal 11 outputs the generated commodity list to the commodity list issuing apparatus 201, which then issues the commodity list acquired from the POS terminal 11 from the printer 204.

Then, the operator acquires the commodity list issued by the commodity list issuing apparatus 201 from the hand of the customer when the customer moves, on the commodity receiving surface 152, the commodity tray 153 to the POS terminal 11, and compares the commodity information contained in the acquired commodity list with the commodities held on the commodity tray 153 to confirm whether or not the commodity information of the commodities held on the commodity tray 153 is contained in the commodity list. If it is confirmed that the commodity information of all the commodities held on the commodity tray 153 is contained in the commodity list, the operator reads the commodity information from the code symbol contained in the commodity list using the scanner 27 configured in the POS terminal 11. Then, the POS terminal 1 records, with reference to the commodity information read by the scanner 27, the commodity ID, the commodity category, the commodity name and the unit price of the commodity specified by the commodity information in a sales primary file (not shown) to implement a sales registration.

Moreover, if the customer moves the commodity tray 153 to the POS terminal 11, without holding any commodity list issued by the commodity list issuing apparatus 201, the operator operates the keyboard 22 to input the commodity information of the commodities held on the commodity tray 153. Then, the POS terminal 1 records, with reference to the input commodity information, the commodity ID, the commodity category, the commodity name and the unit price of the commodity specified by the commodity information in a sales primary file (not shown) to implement a sales registration.

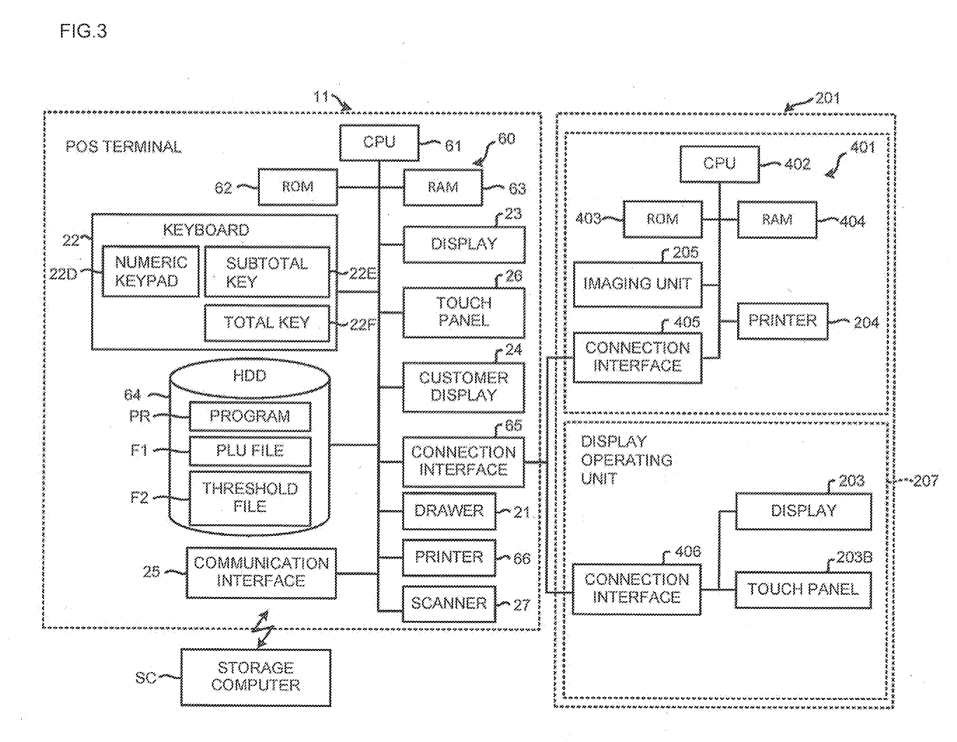

FIG. 3 is a block diagram illustrating the hardware components of the POS terminal and the commodity list issuing apparatus. The POS terminal 11 comprises a micro computer 60 functioning as an information processing unit for carrying out an information processing. The micro computer 60 is formed by connecting a CPU (Central Processing Unit) 61 that carries out various operations to control each other section with an ROM (Read Only Memory) 62 and an RAM (Random Access Memory) 63 via a bus line.

The drawer 21, the keyboard 22, the display 23, the touch panel 26, the customer-oriented display 24 and the scanner 27 are all connected with the CPU 61 of the POS terminal llvia various input/output circuits (not shown). The components connected with the CPU 61 are controlled by the CPU 61.

The keyboard 22 includes including a numeric keypad 22D, a subtotal key 22E and a total key 22F are that numeric characters such as ‘1’, ‘2’, ‘3’ and a multiply operation such as ‘*’ are indicated on its surface. The content input by the operator through the numeric keypad 22D, the subtotal key 22E and the total key 22F are output from the keyboard 22 to the CPU 61. The keyboard 22 is an operating unit accepting the operation of the operator.

The CPU 61 of the POS terminal 1 is connected with an HDD (Hard Disk Drive) 64, in which various programs and files are stored. When run in the POS terminal 11, the programs and files stored in the HDD 64 are all or partially copied into the RAM 63 to be sequentially executed by the CPU 61. An example of the program stored in the HDD 64 is a commodity sales data processing program PR, and an example of the file stored in the HDD64 is a pre-stored PLU file F1 that is sent from a storage computer SC.

The PLU file F1 is a file formed by associating the commodity information specifying a commodity sold in a shop with the commodity image specified by the commodity information. FIG. 4 is a conceptual diagram exemplarily showing the data structure of the PLU file. As shown in FIG. 4, the PLU file F1 stores, aiming at a commodity ID uniquely distributed to a commodity, specific commodity information such as the range to which the commodity belongs, that is, the commodity category, the commodity name and the unit price of the commodity in association with the commodity image of the imaged commodity.

Return to FIG. 3, the CPU 61 of the POS terminal 1 is connected with a communication interface 25 that communicates in data with the storage computer SC via an input-output circuit (not shown). The storage computer SC is configured inside a shop. The PLU file F1 to be sent to the POS terminal 11 is stored in the HDD (not shown) of the storage computer SC.

The CPU 61 of the POS terminal 11 is connected with a connection interface 65 that can transmit data with the commodity list issuing apparatus 201. Therefore, the connection interface 65 is connected with the commodity list issuing apparatus 201. Moreover, the CPU 61 of the POS terminal 11 is also connected with a printer 66 for printing invoices. The POS terminal 11 prints the content (such as settlement amount, granted point, etc.) of a transaction on a receipt under the control of the CPU 61.

The commodity list issuing apparatus 201 also has a micro computer 401, which is formed by connecting a CPU 402 with an ROM 403 and an RAM 404 via a bus line. The programs executed by the CPU 402 are stored in the ROM 403. The frame image imaged by the imaging unit 205 is stored in the RAM 404. The CPU 402 is connected with the imaging unit 205 and the printer 204 via various input/output circuits (not shown). The imaging unit 205 and the printer 204 both act under the control of the CPU 402. The display operating unit 207 is connected with the POS terminal 11 via a connection interface 406 and acts under the control of the CPU 402 of the commodity list issuing apparatus 201.

The imaging unit 205 is a CCD (Charged Coupled device) video sensor or a CMOS (Complementary Metal Oxide Semiconductor) video sensor which images, under the control of the CPU 402, an image in which the commodity images of the commodities held on the commodity tray 153 are contained. For instance, the imaging unit 205 images a 30FPS dynamic image. The frame images (images) sequentially imaged by the imaging unit 205 at a given frame rate are stored in the RAM 404. The printer 204 prints a commodity list under the control of the CPU 402.

Further, the CPU 402 is connected with a connection interface 405 which is connected with the connection interface 65 of the POS terminal 11 to transmit data with the POS terminal 11. The connection interface 405 may acquire a commodity list from the POS terminal 11 or send the frame images stored in the RAM 404 to the POS terminal under the control of the CPU 402.

Next, the functional units of the CPU 61 and the CPU 402 achieved by the sequential program running of the CPU 61 and the CPU 402 are described below with reference to FIG. 5. FIG. 5 is a block diagram illustrating the functional components of the POS terminal and the commodity list issuing apparatus. As shown in FIG. 5, by executing programs sequentially, the CPU 402 gains the functions of an image acquisition section 501, a commodity detection section 502, an image output section 503 and a commodity list issuing section 504, and in the same way, the CPU 61 gains the functions of an object recognition section 505, a commodity list generation section 506, a commodity list output section 507 and a commodity registration section 508.

The image acquisition section 501 outputs an imaging switch-on signal to the imaging unit 205 to activate the imaging unit 205 to carry out an imaging. The image acquisition section 501 sequentially acquires, in accordance with the storage order of the RAM 404, the frame images that are imaged by the imaging unit 205 and stored in the RAM 404.

The commodity detection section 502 detects all or part of the commodity images contained in the frame image acquired by the image acquisition section 501 using a pattern matching technology. Specifically, the commodity detection section 502 compares the binarized outline of the acquired frame image with that extracted from the current frame image to detect the difference, that is, detect the mapping of a commodity entering the imaging range of the imaging unit 205 to be issued in an issuing list. Moreover, in another commodity image detection method, the commodity detection section 502 detects the existence/absence of the image of the commodity tray 153 according to the acquired frame image. If the image of the commodity tray 153 is detected, that is, the mapping of the commodity tray 153 is detected, the commodity detection section 502 attempts to extract the outline of the image of the commodities assumed to be held on the commodity tray 153 by detecting the outline. Moreover, the commodity detection section 502 detects the mapping of the commodity image according to the fact that commodities are held on the commodity tray 153 if the outlines of the commodity tray 153 and the commodity image are detected.

The image output section 503 outputs the frame image containing the commodity images detected by the commodity detection section 502 to the POS terminal 11 via the connection interface 405. Moreover, in this embodiment, the image output section 503 outputs the frame image containing the commodity images detected by the commodity detection section 502 to the POS terminal 11, however, the present invention is not limited to this, the frame images acquired by the image acquisition section 501 may also be sequentially sent to the POS terminal 11, or a frame image is that all or part of the commodity images is detected by the commodity detection section 502 is sent to the POS terminal 11. In this way, through the frame image containing all or part of the commodity images detected by the commodity detection section 502 is sent to the POS terminal 11, thus it may prevent that is referred to PLF file F1 and carried out object recognition based on the frame image not containing all or part of the commodity images in the POS terminal 11. The recognition of a specific object becomes necessary to take time, however, according to this way, it may prevent to process in the flame image that does not contain all or part of the commodity images and there is no prospect of the recognition of a specific commodity, thus, the processing time is able to be reduced.

The object recognition section 505 is a commodity recognition section which recognizes a commodity from a commodity image contained in the acquired frame image (the frame image output from the image output section 503) with reference to the commodity images contained in the PLU file F1. Specifically, by reference to the commodity images contained in the PLU file F1, the object recognition section 505 reads a color tone, a flatness level or other surface states from the commodity images contained in the acquired frame image as characteristics to recognize a commodity serving as a specific object. Moreover, the object recognition section 505 takes no consideration of the outline or size of a commodity so as to shorten the processing time.

The recognition of an object contained in an image is referred to as generic object recognition, which is realized by using the technologies that are illustrated in the following document:

YANAI Keiji, ‘The current state and further directions on Generic Object Recognition’, in Proceedings of Information Processing Society of Japan, Vol. 48, No SIG 16, In URL:http://mm.cs.uec.ac.jp/IPSJ-TCVIM-Yanai.pdf [retrieved on Aug. 10, 2010]

In addition, the technology for recognizing an ordinary object through targeted regional image segmentation is described in the following document:

Jamie Shotton: “Semantic Texton Forests for Image Categorization and Segmentation, In URL:http://citeseerx.ist.psu.edu/viewdoc/download?doi=10.1. 1.145.3036&rep=rep1&type=pdf (retrieved on Aug. 10, 2010).

The commodity list generation section 506 generates a commodity list in which the commodity information (the commodity information in the FLU file F1 associated with the commodity image of the commodity recognized by the object recognition section 505) specified by the commodity recognized by the object recognition section 505 and the code symbol generated by coding the commodity information are contained.

The commodity list output section 507 outputs the commodity list generated by the commodity list generation section 506 to the commodity list issuing apparatus 201 through the connection interface 65. Moreover, in this embodiment, the commodity list output section 507 outputs the commodity information of the commodity recognized by the object recognition section 505 to the commodity list issuing apparatus 201 through the connection interface 65.

The commodity list issuing section 504 controls the printer 204 to print the generated commodity list (the commodity list output by the commodity list output section 506) on a recording medium and issues the commodity list.

In this embodiment, before issuing a commodity list, the commodity list issuing section 504 displays, on the display 203, the commodity information of the commodity recognized by the object recognition section 505 as well as an issuing button (not shown) for requesting the issue of the commodity list. Moreover, the commodity list issuing section 504 issues the commodity list after detecting, using the touch panel 203B, that the issuing button displayed on the display 203 is pressed.

The commodity registration section 508 records the commodity information read by the scanner 27 from the code symbol contained in the commodity list in a sales primary file and implements a commodity sales registration.

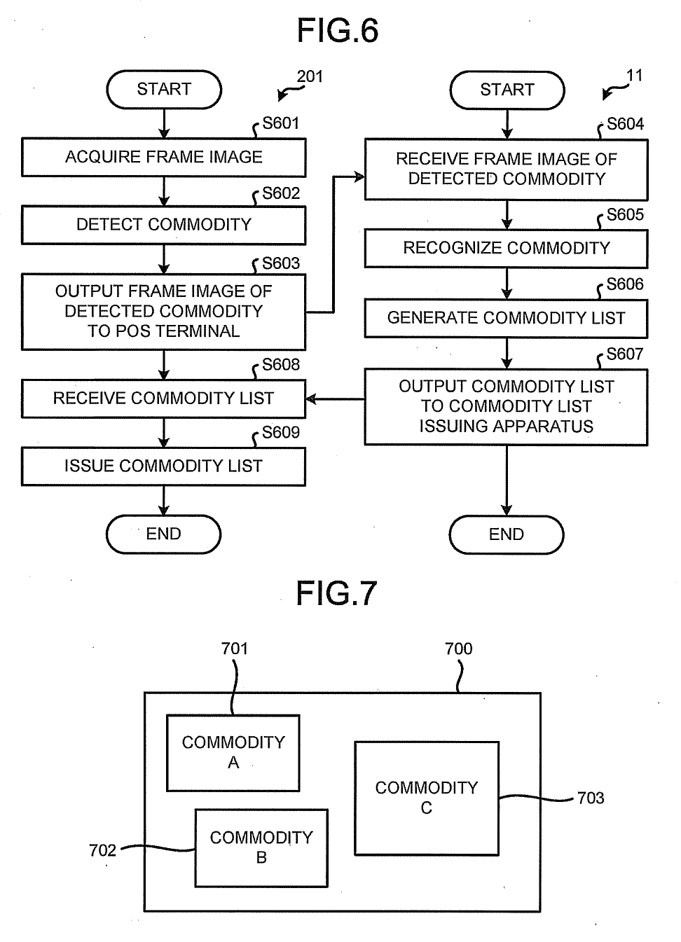

Next, the commodity list issuing actions implemented by the settlement system 1 are described in detail below. FIG. 6 is a flow chart showing an example of the commodity list issuing actions implemented by the settlement system according to an embodiment of the present invention.

The actions implemented at the side of the commodity list issuing apparatus 201 are first described. The image acquisition section 501 outputs an imaging switch-on signal to the imaging unit 205 to activate the imaging unit 205 to carry out an imaging. Then, the image acquisition section 501 acquires the frame images that are imaged by the imaging unit 205 and stored in the RAM 404 (Act S601). FIG. 7 is a diagram showing an example of an acquired frame image. As shown in FIG. 7, the image acquisition section 501 may acquire a frame image 700 containing the commodity images 701-703 of a plurality of commodities A-C held on the commodity tray 153. The processing carried out during the acquisition of the frame image 700 shown in FIG. 7 by the image acquisition section 501 will be illustrated in the following description.

After the image acquisition section 501 acquires the frame image 700, the commodity detection section 502 detects all or part of the commodity images 701-703 contained in the frame image 700 (Act S602). If the commodity images 701-703 are detected by the commodity detection section 502, the image output section 503 outputs the frame image 700 containing the detected commodity images 701-703 to the POS terminal 11 (Act S603).

Next, the actions implemented in the side of the POS terminal 11 are described. The object recognition section 505 receives the frame image output from the image output section 503 (Act S604). Then, by reference to the commodity images contained in the PLU file F1, the object recognition section 505 reads a color tone, a flatness level or other surface states from the commodity images contained in the acquired frame image (the frame image output by the image output section 503) as characteristics to recognize the commodities A-C serving as specific objects (Act S605).

The commodity list generation section 506 generates a commodity list in which the commodity information of the commodities A-C recognized by the object recognition section 505 and the code symbol generated by coding the commodity information are contained (Act S606). Then, the commodity list output section 507 outputs the commodity list generated by the commodity list generation section 506 to the commodity list issuing apparatus 201 (Act S607).

Return to the description on the actions implemented at the side of the commodity list issuing apparatus 201, the commodity list issuing section 504 receives the commodity list output from the commodity list output section 507 (Act S608), and then controls the printer 204 to issue the received commodity list (Act S609).

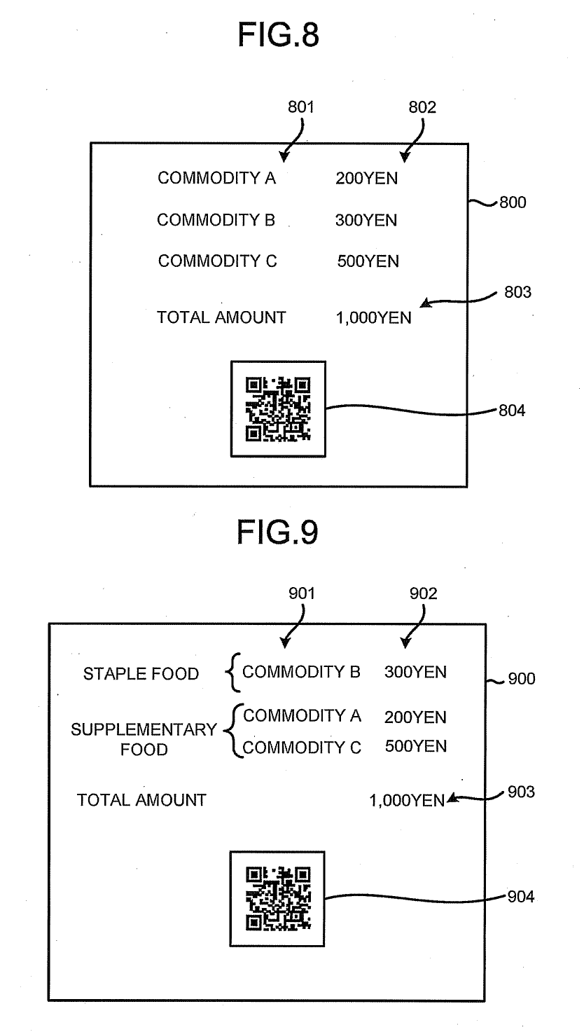

FIG. 8-FIG. 11 are diagrams each showing an example of a commodity list generated by the commodity list generation section. For instance, as shown in. FIG. 8, the commodity list 800 generated by the commodity list generation section 506 contains commodity names 801, unit prices 802 and a two-dimensional code 804 generated by coding the commodity information (that is, commodity ID, commodity category, commodity name and unit price) of the commodities recognized by the object recognition section 505. Moreover, as shown in FIG. 8, the commodity list 800 generated by the commodity list generation section 506 may further contain a total unit price 803 serving as the commodity information of the recognized commodities.

Further, as shown in FIG. 9, in the commodity list 900 generated by the commodity list generation section 506, commodity names 901 and unit prices 902 of the commodity information (that is, commodity ID, commodity category, commodity name and the unit price) of the commodities recognized by the object recognition section 505 are configured according to the range the commodities specified by the commodity information belong to, that is, the commodity category (staple food or supplementary food), and a two-dimensional code 904 generated by coding the commodity information is also contained in the commodity list 900. Moreover, as shown in FIG. 9, the commodity list 900 generated by the commodity list generation section 506 may further contain a total unit price 903 serving as the commodity information of the recognized commodities.

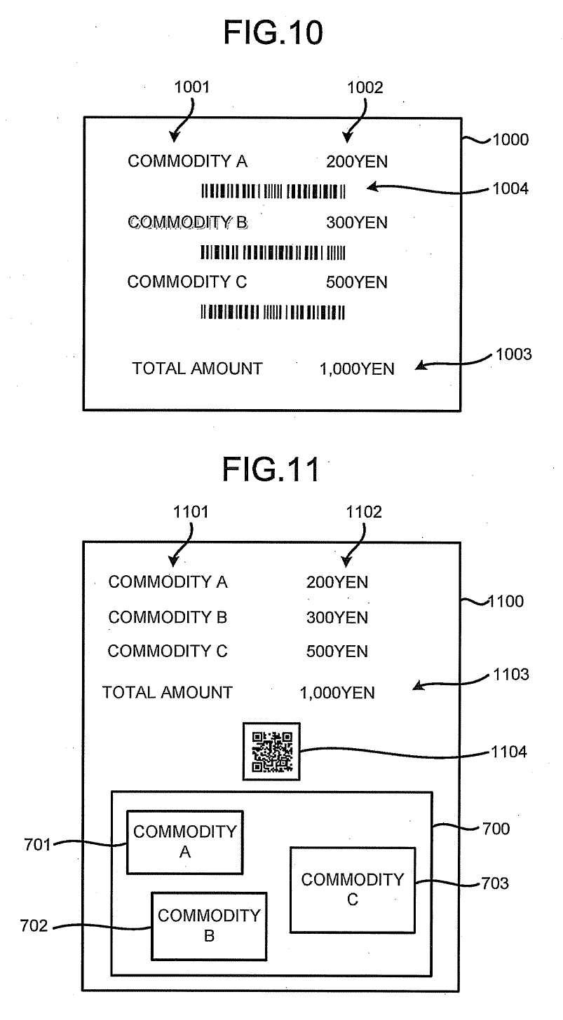

Moreover, as shown in FIG. 10, the commodity list 1000 generated by the commodity list generation section 506 contains commodity names 1001, unit prices 1002 and a two-dimensional code 1004 generated by coding the commodity information (that is, commodity ID, commodity category, commodity name and unit price) of the commodities recognized by the object recognition section 505:. Moreover, as shown in FIG. 10, the commodity list 1000 generated by the commodity list generation section 506 may further contain a total unit price 1003 serving as the commodity information of the recognized commodities.

For instance, as shown in FIG. 11, in addition to commodity names 1101, unit prices 1102 and a two-dimensional code 1104 generated by coding the commodity information (that is, commodity ID, commodity category, commodity name and unit price) of the commodities recognized by the object recognition section 505, the commodity list 1100 generated by the commodity list generation section 506 further contains a frame image 700 acquired by the image acquisition section 501. Moreover, as shown in FIG. 11, the commodity list 1100 generated by the commodity list generation section 506 may further contain a total unit price 1103 serving as the commodity information of the recognized commodities.

Moreover, in this embodiment, the commodity list generation section 506 contains the frame image 700 in the commodity list 1100, however, the present invention is not limited to this, the commodity images 701-703 contained in the frame image 700 may also be replaced with the marks that are preconfigured for the commodities A-C to generate the commodity list.

In this way, in accordance with this embodiment, through the settlement system 1 acquires the frame image imaged by the imaging unit 205, recognizes commodities based on the commodity images contained in the acquired frame image and generates and issues a commodity list which contains the commodity information for specifying the recognized commodities and a code symbol generated by coding the commodity information, the commodity information can be input by reading the code symbol contained in the commodity list with a commodity reading apparatus 101 and it is not necessary to input the commodity information one by one, thus, cashier's burden may lighten. Moreover, by checking the commodity information contained in the commodity list to confirm whether or not all the commodities are contained in the commodity list, the possibility of the occurrence of an undesired incomplete commodity information input is reduced.

The programs executed by the POS terminal 11 and the commodity list issuing apparatus 201 described in this embodiment are pre-compiled in the ROM, or be stored in a computer-readable recording medium such as CD-ROM, FD (floppy drive), CD-R, DVD (digital versatile disk) as an installable or executable file,

or be stored in a computer connected with a network such as the Internet to be provided through a network download, or provided or published by a network such as the Internet.

The programs executed by the POS terminal 11 and the commodity list issuing apparatus 201 consist of modules including all the above-mentioned sections (the image acquisition section 501, the commodity detection section 502, the image output section 503, the commodity list issuing section 504, the object recognition section 505, the commodity list generation section 506, the commodity list output section 507 and the commodity registration section 508); as an actual hardware, the CPU (processor) reads the programs from the ROM and executes the read programs to load all the above-mentioned sections on a primary storage device to generate the image acquisition section 501, the commodity detection section 502, the image output section 503, the commodity list issuing section 504, the object recognition section 505, the commodity list generation section 506, the commodity list output section 507 and the commodity registration section 508 thereon.

Moreover, in this embodiment, the CPU 61 of the POS terminal 11 can function as the object recognition section 505 and the commodity list generation section 506, however, the present invention is not limited to this, the CPU 402 of the commodity list issuing apparatus 201 may also function as the object recognition section 505 and the commodity list generation section 506 so that a commodity list can be issued by only using the commodity list issuing apparatus 201.

Moreover, in this embodiment, the CPU 402 of the commodity list issuing apparatus 201 can function as the image acquisition section 501, the commodity detection section 502, the image output section 503 and the commodity list issuing section 504, however, the present invention is not limited to this, the CPU 61 of the POS terminal 11 may also function as the image acquisition section 501, the commodity detection section 502, the image output section 503 and the commodity list issuing section 504 so that a commodity list can be issued by only using the POS terminal 11.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A commodity list issuing apparatus, comprising:
an acquisition section configured to acquire an image;
a commodity recognition section configured to recognize a commodity according to the acquired image in which the commodity is contained;
a generation section configured to generate the commodity information specifying the recognized commodity and a commodity list contains a code symbol generated by coding the commodity information; and
an issuing section configured to issue the generated commodity list.

2. The commodity list issuing apparatus according to claim 1, wherein
the generation section generates the commodity list that the commodity information is arranged according to a category of the commodity specified by the commodity information.

3. The commodity list issuing apparatus according to claim 1, wherein
the generation section generates the commodity list in which the acquired image is contained.

4. The commodity list issuing apparatus according to claim 2, wherein
the generation section generates the commodity list in which the acquired image is contained.

5. The commodity list issuing apparatus according to claim 3, wherein
the generation section generates the commodity list contains the image that is replaced the image of the commodity contained in the acquired image with a mark which stands for the commodity.

6. The commodity list issuing apparatus according to claim 4, wherein
the generation section generates the commodity list contains the image that is replaced the image of the commodity contained in the acquired image with a mark which stands for the commodity.

7. A commodity list issuing method, comprising:
acquiring an image;
recognizing a commodity according to the acquired image in which the commodity is contained;
generating a commodity information specifying the recognized commodity and a commodity list contains a code symbol generated by coding the commodity information; and
issuing the generated commodity list.
